(19) United States
(12) Patent Application Publication
(10) Pub. No.: US 2017/0191628 A1
(43) Pub. Date: Jul. 6, 2017

(54) RETROFIT DOWNLIGHT WITH INTERCHANGEABLE TRIM

(71) Applicant: HALCO LIGHTING TECHNOLOGIES, LLC, Norcross, GA (US)

(72) Inventors: David R. NELKIN, Atlanta, GA (US); Ed MACKIEWICZ, Fayetteville, GA (US)

(73) Assignee: HALCO LIGHTING TECHNOLOGIES, LLC, Norcross, GA (US)

(21) Appl. No.: 15/291,472

(22) Filed: Oct. 12, 2016

Related U.S. Application Data
(60) Provisional application No. 62/274,587, filed on Jan. 4, 2016.

(51) Int. Cl. F21S 8/04; F21V 19/00; F21V 21/108; F21K 9/237; F21V 23/00; F21V 17/00; F21V 3/00; F21V 17/16; F21V 23/06; F21K 9/235

(52) U.S. Cl. CPC F21S 8/04; F21V 23/06; F21V 19/006; F21V 21/108; F21K 9/235; F21V 23/001; F21V 17/002; F21V 3/00; F21V 17/164; F21K 9/237; F21Y 2115/10

(57) ABSTRACT

A retrofit downlight including a light source, a housing, and one or more interchangeable trim members. The housing includes a trim connection plate with trim connection openings extending therethrough. The interchangeable trim member includes at least one engagement clip that is cooperatively interengageable with the trim connection openings for positive mechanical attachment of the interchangeable trim member to the trim connection plate.

### CROSS-REFERENCE TO RELATED APPLICATION

This application claims the benefit of U.S. Provisional Patent Application Ser. No. 62/274,587 filed Jan. 4, 2016, the entirety of which is hereby incorporated herein by reference for all purposes.

### TECHNICAL FIELD

The present invention relates generally to the field of residential and commercial lighting, and more particularly to retrofit downlight fixture having a replaceable or interchangeable trim piece.

### BACKGROUND

Retrofit downlight or “can” light fixtures can be used to update a previously installed fixture, for example to convert an incandescent fixture to an LED or other high-efficiency lighting format. Such retrofit fixtures may include a cover or trim piece to cover gaps between the retrofit fixture and the previously installed fixture and/or the surrounding ceiling, to cover mounting hardware, and/or otherwise provide an aesthetically pleasing appearance to the installed retrofit fixture. A single trim piece is commonly provided for permanent installation with the retrofit fixture. Thus, if it is later desired to change or alter the appearance of the downlight, the user must buy an entirely new downlight or retrofit fixture having the desired appearance and trim.

Some lighting fixtures may allow replacement of trim pieces by magnetic or adhesive attachment. Such attachment means, however, may have disadvantages in terms of unintentional detachment of the trim piece from the fixture if the magnet or adhesive weakens, inability to remove an adhesively attached trim piece from a fixture without damage, and misalignment of the trim piece relative to the fixture upon installation.

Thus, it can be seen that needs exist for improved retrofit downlight fixtures having interchangeable trim pieces allowing users to customize or change the appearance of their lighting fixtures without replacement of the entire fixture, meeting these and other needs that the present invention is primarily directed.

### SUMMARY

In example embodiments, the present invention provides a retrofit downlight fixture having an interchangeable trim piece. Interchangeable trim pieces can optionally be provided in multiple styles, colors, textures, and/or finishes, and are generally removably coupled to a trim connection plate of a housing of the retrofit downlight fixture by positive mechanical attachment.

In one aspect, the invention relates to a retrofit downlight apparatus including a housing configured for retrofit installation within a preexisting ceiling downlight fixture, a light module comprising a light source, and at least one mounting arm for securing the housing within the preexisting ceiling downlight fixture. The retrofit downlight further includes a trim connection plate extending from the housing and having at least one first trim coupling element, and at least one interchangeable trim piece having at least one second trim coupling element. The first and second trim coupling elements are cooperatively interengageable to provide removable positive mechanical attachment of the trim piece with the trim connection plate.

Multiple interchangeable trim pieces can be provided with the retrofit apparatus, each having a different external appearance. In this manner, a user can select a preferred trim piece from a plurality of interchangeable trim pieces for installation with the fixture to provide their desired aesthetic result.

In another aspect, the invention relates to a retrofit downlight apparatus including a light source mounted within a housing. The housing preferably includes a trim connection plate having a plurality of trim connection openings extending therethrough. The retrofit apparatus also includes a trim member having a central opening, an outer trim ring, and a central baffle between the outer trim ring and the central opening. The trim member further includes a plurality of trim engagement clips extending from the outer trim ring, each trim engagement clip configured for cooperative engagement with a corresponding one of the trim connection openings

In still another aspect, the invention relates to a retrofit downlight apparatus including a housing, a light module comprising an LED light source mounted to the housing, and a trim connection plate extending from the housing. The trim connection plate preferably includes at least three trim connection openings extending therethrough. The retrofit downlight apparatus also includes at least one interchangeable trim piece, the at least one interchangeable trim piece including at least three engagement clips. Each engagement clip is configured for cooperative interengagement with one of the trim connection openings to attach the at least one interchangeable trim piece to the housing.

In another aspect, the invention relates to a method installation of a retrofit downlight apparatus, the apparatus comprising a housing, a light module mounted to the housing, and a trim connection plate extending from the housing and having at least one trim connection feature provided thereon. The method preferably includes selectively attaching a selected one of a plurality of visually different interchangeable trim pieces by positive mechanical engagement of the selected trim piece with the at least one trim connection feature of the trim connection plate

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description are exemplary and explanatory of embodiments of the invention, and are not restrictive of the invention, as claimed.

### BRIEF DESCRIPTION OF THE DRAWINGS

FIG. 1 is a front perspective view of a retrofit downlight fixture according to an example embodiment of the present invention.

FIG. 2 is a rear perspective view of the retrofit downlight fixture of FIG. 1.

FIG. 3 is a plan view of the exterior side of the retrofit downlight of FIG. 1 without the trim piece installed.

FIG. 4 is a plan view of the interior side of an interchangeable trim piece for a retrofit downlight fixture according to an example embodiment of the present invention.

FIG. 5 is a perspective of the removable trim piece of FIG. 4, from the interior side.

FIG. 6 is a perspective view of a portion of the retrofit downlight of FIG. 3, wherein the trim piece is not installed.

FIGS. 7-10 show a sequence of installation of an interchangeable trim piece onto the trim connection plate of the retrofit downlight according to an example assembly method of the present invention.

FIG. 11 shows a perspective view of an exterior side portion of the interchangeable trim piece of FIG. 4.

FIG. 12 shows a perspective view of an exterior side portion of an interchangeable trim piece according to another example embodiment of the present invention, having a different appearance than the trim piece of FIG. 11.

FIG. 13 shows exterior side views of two retrofit downlight fixtures of differing fixture sizes.

FIG. 14 shows an assembly view of a retrofit downlight fixture for installation into a previously installed downlight fixture, with multiple different trim pieces interchangeably mountable to the retrofit fixture.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that the invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

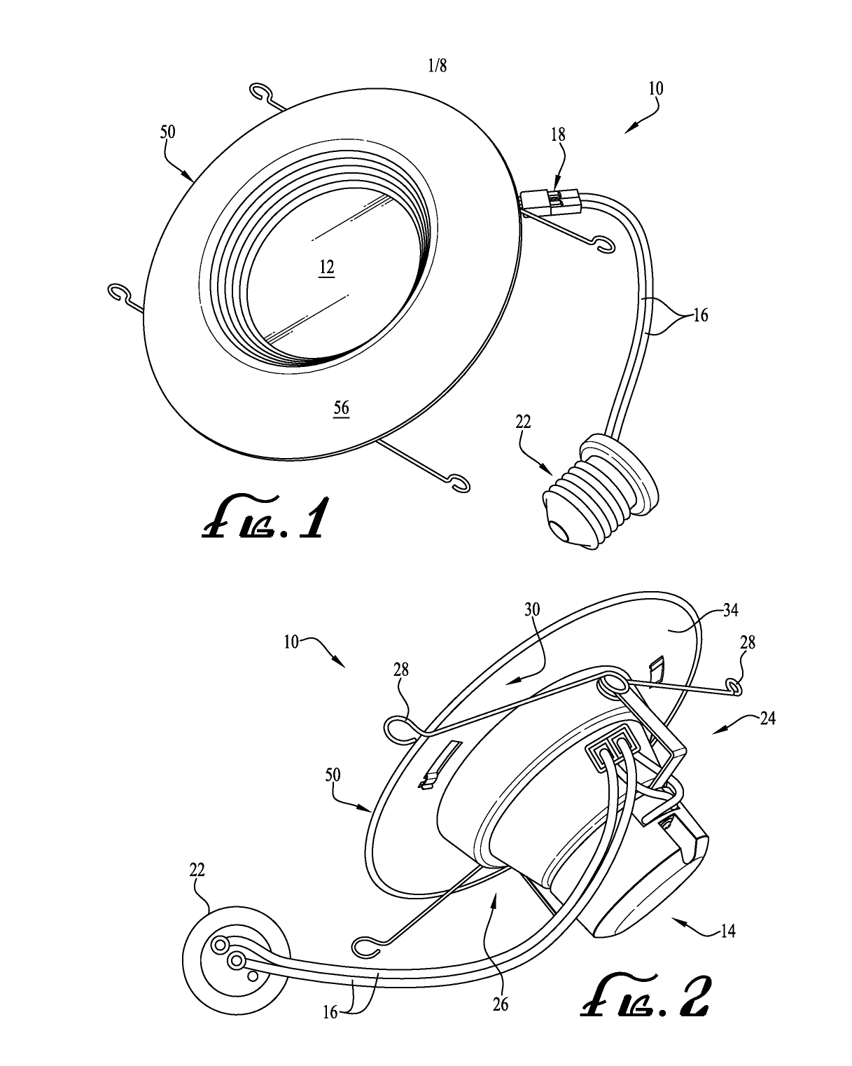

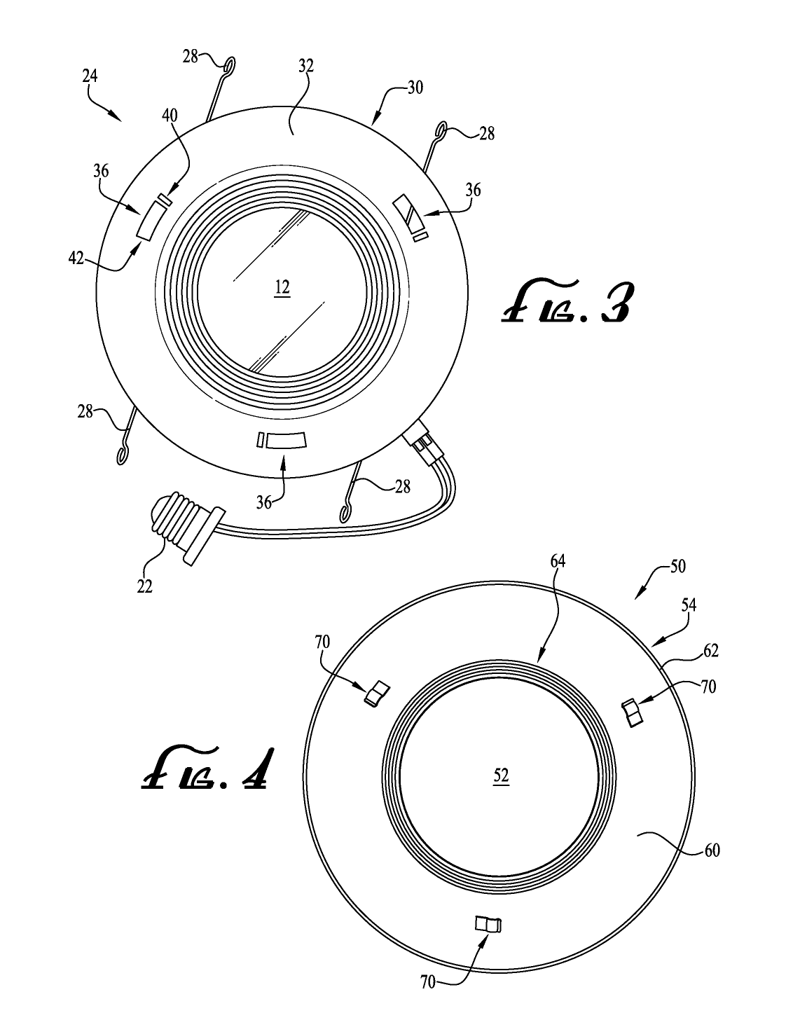

With reference now to the drawing figures, wherein like reference numbers represent corresponding parts throughout the several views, FIGS. 1-3 show a retrofit downlight fixture 10 according to an example embodiment of the present invention. In example forms, the retrofit downlight 10 generally comprises a translucent or transparent light diffuser 12, an electronic lighting module 14, electrical conductor wiring 16, a wiring coupling or connector 18, a threaded Edison-type or other plug 22 for retrofit connection to the socket or other electrical connection of a preexisting light fixture to which the retrofit fixture is to be attached, and a housing 24. In example embodiments, the housing 24 comprises a generally cylindrical or conical lighting body portion 26 and a trim connection collar or plate 30 extending radially and generally transversely outward from the exterior or distal end of the lighting body portion 26. The retrofit fixture 10 further comprises one or more interchangeable decorative trim members 50 configured for removable attachment to the trim connection collar or plate 30, as described in greater detail below.

In example forms, the electronic lighting module 14 comprises a light-emitting diode (LED) or other high-efficiency light source, and transformer, ballast, heat sink, and/or other operational components for the light source. In this manner, the standard (e.g., incandescent) bulb or lamp of the previously installed downlight fixture is removed, and the retrofit fixture 10 is installed in its place within the can housing of the previously installed fixture F, to replace an old low-efficiency light source with a new high-efficiency light source, without the need for rewiring or installation of an entirely new light fixture. The retrofit fixture 10 comprises one or more (in the depicted embodiment, four, configured in two opposed pairs) spring-biased, resilient mounting arm connectors 28, or other mounting components affixed to its housing 24, for engagement with the “can” or housing of a previously installed ceiling-mounted downlight fixture F, as shown in FIG. 14.

In example forms, the retrofit downlight fixture 10 is sized and shaped to fit within the can housing of the previously installed fixture F, such that a substantial majority of the retrofit fixture is generally recessed into the ceiling C. For example, for retrofit compatibility with a 4″ (nominal) downlight fixture F, the interior components (lighting module 14, housing 24) of the retrofit fixture 10 have a maximum outer dimension of no more than about 2.7 inches. For retrofit compatibility with a 6″ (nominal) downlight fixture F, the interior components have a maximum outer dimension of no more than about 3.6 inches. Conversely, the mounting arm connectors 28 are constructed to be compressed into a smaller installation configuration capable of insertion into the previously installed fixture F, and to extend into a larger engagement configuration providing a firm and positive engagement of the retrofit fixture 10 within the housing of the previously installed fixture F.

To install the retrofit fixture 10, the bulb or lamp of the previously installed downlight fixture F is unscrewed or otherwise removed from the previously installed fixture. The Edison plug 22 or other electrical coupling of the retrofit fixture 10 can be detached from the retrofit fixture by decoupling the connector 18, and is then screwed into the socket or otherwise connected to the previously installed fixture F. The connector 18 is then reattached to electrically connect the retrofit fixture 10 to the existing wiring of the previously installed fixture F, and the spring clips 28 are engaged within the can housing of the previously installed fixture to mechanically engage the retrofit fixture in place in the ceiling C.

The retrofit downlight 10 further comprises a removable and interchangeable decorative trim member 50, configured for positive mechanical attachment to the trim connection plate 30 of the lighting body portion 26. The trim member 50 is configured to cover any gaps between the ceiling C and the fixture F, or between the retrofit fixture 10 and the previously installed fixture F, and to conceal the attachment components that mount the trim member to the trim connection plate 30. The replaceable trim member 50 is preferably capable of being removed or installed on the trim connection plate 30 when the retrofit fixture 10 is mounted to the ceiling. Optionally, the downlight 10 may be at least partially removed therefrom to provide for replacement of the trim member 50. In example embodiments, the housing 24 and the trim connection plate 30 may be integrally or separately formed from metals, plastics, composites, or other materials, and the openings 36 may be formed by a stamping or molding process. The replaceable trim member 50 may be similarly constructed of metals, plastics, composites, or other materials, and formed by stamping, molding or other fabrication processes.

As depicted in FIGS. 3-6, the trim connection plate 30 is generally in the form of a circular flange extending around the light 12, which generally forms a portion of the housing 24. In example forms, the trim connection plate 30 generally extends substantially perpendicular relative to the extension of the cylindrical or conical housing portion 26. Typically, the trim connection plate 30 comprises an external surface 32 and an internal surface 34, and whereby a radial array of engagement slots or openings 36 generally extend through the trim connection plate entirely, from the external surface 32 to the internal surface 34. For example, according to one example form, the trim connection plate 30 comprises three engagement openings 36 whereby each of the engagement openings 36 are generally equally spaced apart about the circumference of the circular connection plate 30 (i.e., 120° from one another). Typically, the engagement openings 36 are generally spaced a distance inwardly from the outer periphery of the connection plate 30. As depicted in FIG. 3, the engagement openings 36 preferably each comprise a first opening 40 and a second opening 42. According to one form, the first opening 40 is generally substantially smaller than the second opening 42.

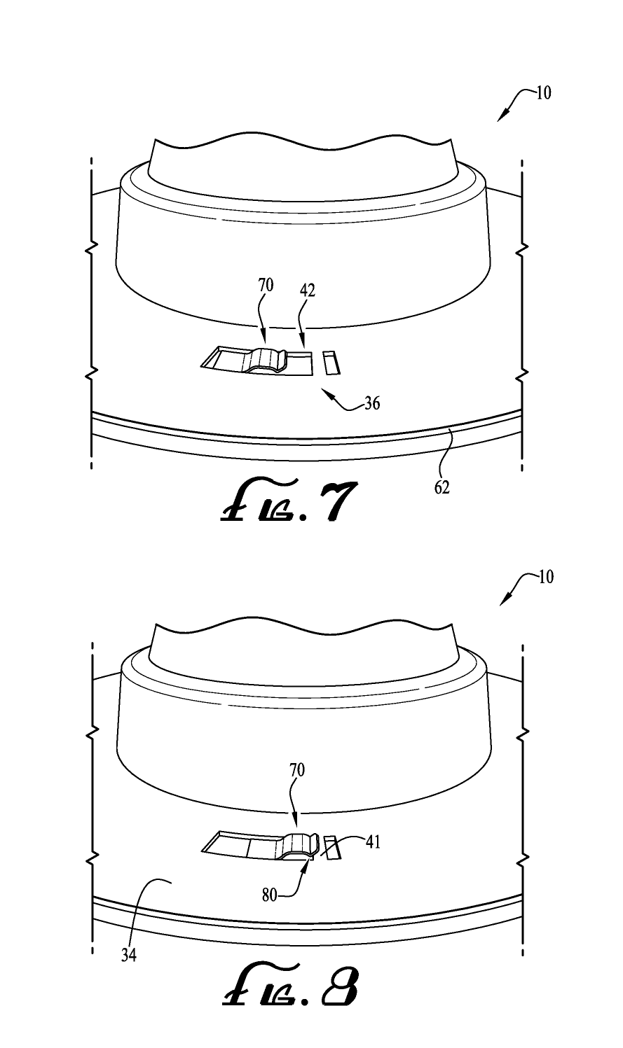

The openings 36 are configured for receiving engagement clips 70 of the replaceable trim member 50 to provide for removable, positive mechanical coupling engagement of the trim member 50 onto the connection plate 30 of the retrofit fixture. In example forms, the openings are generally rectangular in shape and whereby one or more of the sides thereof may be at least partially radiused to substantially match the curvature of the connection plate 30. For example, as depicted in FIG. 6, two of the sides of the second opening 42 are generally radiused to substantially match the curvature of the connection plate 30. Alternatively, the openings 40, 42 may be shaped as desired, for example circular or radial slots, polygonal slots, etc. Furthermore, a rib 41 is formed between the two openings, which generally comprises a thickness T. According to example forms, the thickness T of the rib 41 is substantially similar to the thickness of the connection plate 30. According to example forms, as will be described below, the rib 41 of each of the openings 36 provides for removable coupling engagement with the engagement clips 70 of the replaceable trim 50. In alternate forms, one or more engagement flanges, slots, channels or other attachment features are provided on the connection plate 30 for positive mechanical connection with the clips 70 or other engagement members of the trim member 50. Likewise, depending on the particular configuration of the mounting means, one, two, three, four, or more sets of cooperative engagement members may be provided for engagement of the replaceable trim member 50 with the connection plate 30 of the retrofit fixture.

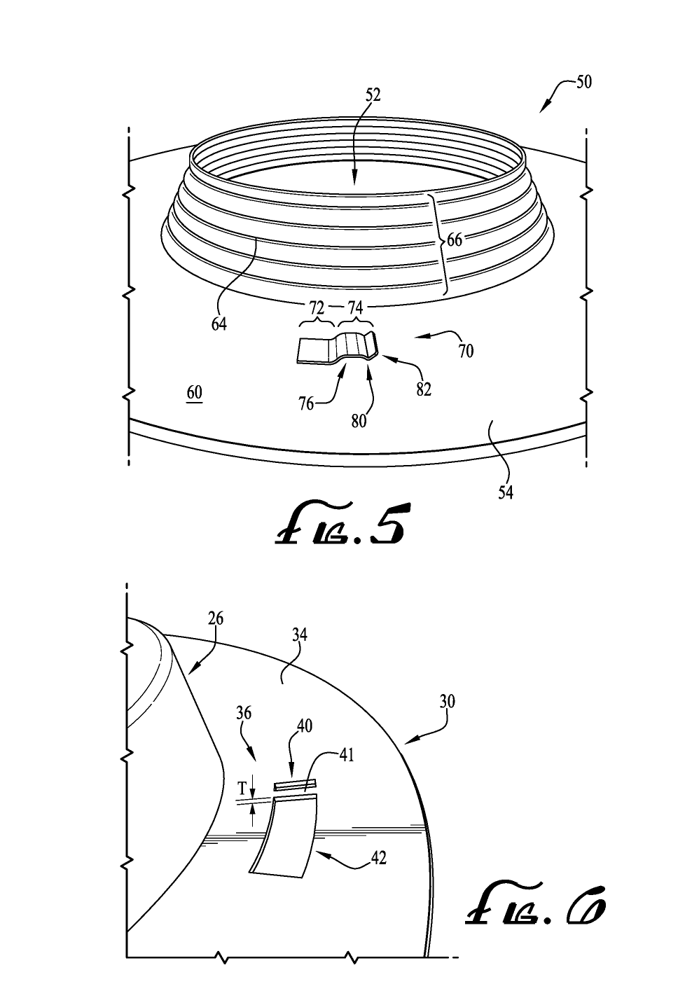

As depicted in FIG. 4, the replaceable trim member 50 comprises an annular body having a central opening 52 and a generally circular outer trim ring 54. The outer trim ring 54 comprises a lip 62 generally extending perpendicular relative to the outer trim ring 54 along the outer periphery thereof. The lip 62 is preferably configured for being positioned along the outer periphery of the trim connection plate 30 when the replaceable trim 50 is coupled to the trim connection plate 30, for example, to appear as though the assembly of the replaceable trim 50 with the trim connection plate 30 is an integral piece (see FIGS. 1-2, and 7). A central baffle 64 extends obliquely inwardly from the outer trim ring 54 generally adjacent the opening 52 in an inward direction towards a central axis that is axially-positioned within the opening 52. According to some example forms, the baffle 64 comprises one or more steps 66 formed thereon to provide the baffle 64 a ribbed surface. As shown in FIG. 3, the housing 24 or a portion mounted thereto and generally surrounding the light 12 comprises a baffle portion that is generally similar to the baffle 64 of the replaceable trim 50. According to example forms, the baffle 64 is generally sized to seat against the baffle that is surrounding the light 12, and whereby the end of the baffle 64 generally abuts against a portion of the baffle or the light 12 centrally-positioned within the central region defined by the baffle. Optionally, as will be described below, the baffle 64 may be formed as desired, for example, with a stepped surface, a smooth surface, and/or may be in one or more colors or finishes.

In example forms, the outer trim ring 54 comprises an exterior surface 56 and an interior surface 60. In the depicted example embodiment, the interior surface 60 of the outer trim ring 54 comprises a radial array of three engagement clips 70 that are generally spaced apart similarly to the openings 36 such that they are capable of providing removable engagement between the trim connection plate 30 and the replaceable trim 50. For example, according to one example form, the second opening 42 is generally sized and shaped to receive the engagement clips 70 of the replaceable trim 50, and whereby rotational movement of the replaceable trim 50 relative to the trim connection plate 30 causes engagement or disengagement of the replaceable trim 50 with the trim connection plate 30.

As depicted in FIG. 5, each of the engagement clips 70 generally comprise a mounted portion or base 72 and a free portion or arm 74. For example, the clips 70 can be formed as a metal tab or thin metal plate, having a first end fixedly or rigidly attached to the trim ring 54, a free second end opposite the attached first end, and a flexible and resilient medial body portion between the first and second ends. According to example forms, the engagement clips 70 are at least partially resilient or flexible, whereby engagement/disengagement with the openings 36 does not cause wear or bending thereof such that the engagement clips 70 no longer function properly (as will be described below). According to one example embodiment, the base 72 is generally permanently mounted to the bottom surface 60 of the outer trim ring 54, for example, by tack welding. Optionally, adhesives, fasteners, etc. may be provided to secure the clips 70 to the bottom surface 60. Optionally, the engagement clips 70 may be permanently or removably engageable with the outer trim ring 54. Alternatively, the engagement clips 70 may be integrally formed with the bottom surface 60 during the casting, stamping or molding process thereof.

The arm 74 of the clip 70 is preferably at least partially offset a distance from the bottom surface 60 of the outer trim ring 50, for example at a distance that is generally slightly less than the thickness T of the rib 41. Thus, during engagement thereof, the arm 74 is at least partially engaged with a portion of the opening 36 or rib 41 to prevent inadvertent disengagement. According to example forms, the arm 74 generally comprises a first section 76 having a generally U-shape or arc-like shape, which is connected to an end fold or edge 80, which is further connected to an end ramp 82. Preferably, the sections and general shapes thereof provide for removable but positive mechanical coupling engagement of the trim piece 50 with the trim connection plate 30 of the retrofit fixture, such that the arm 74 of the engagement clip is capable of removably engaging the first and second openings 40, 42 and the rib 41 therebetween. For example, FIGS. 7-10 show a sequence of operation of the engagement clips 70 for providing removable engagement of the replaceable trim piece 50 with the outer trim ring 54. As shown in FIG. 7, with the replaceable trim 50 generally axially aligned with the trim connection plate 30, and with the bottom surface 60 of the replaceable trim 50 generally seated against the top surface 32 of the trim connection plate 30, the engagement clips 70 are positioned within the second openings 42. Preferably, there is little to no interference between the engagement clip 70 and the second opening 42 such that the replaceable trim 50 is capable of at least some rotation relative to the trim connection plate 30.

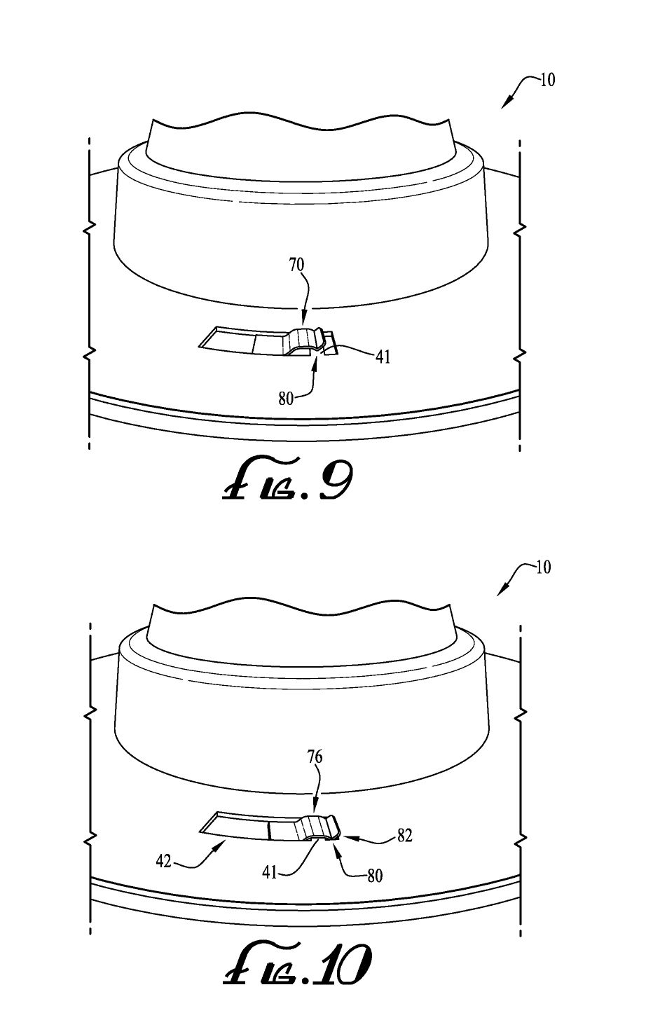

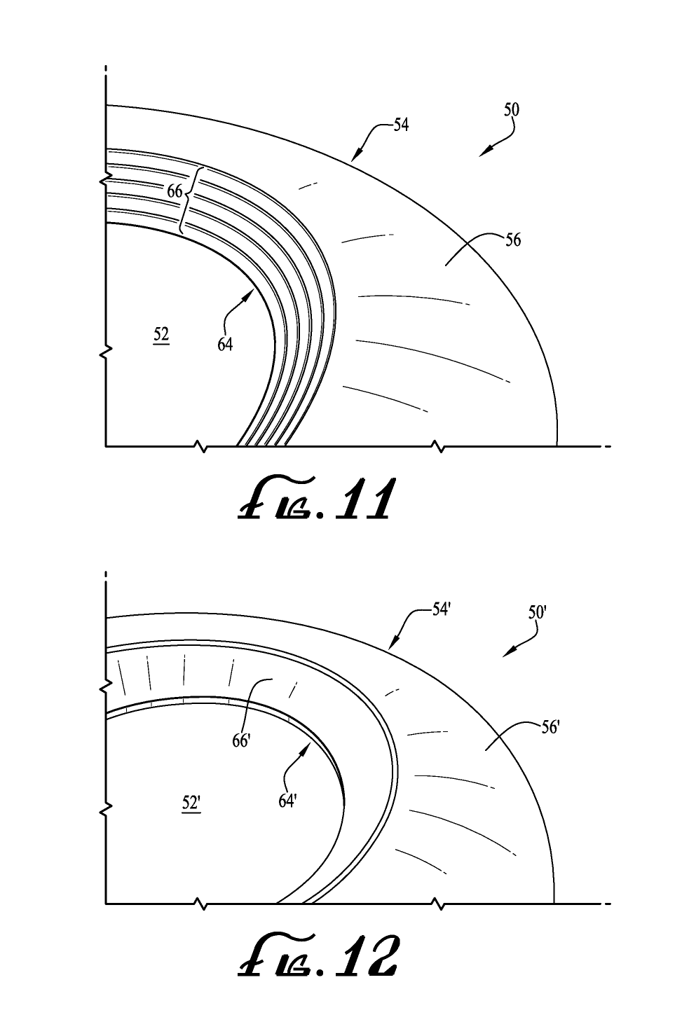

As depicted in FIG. 8, the removable trim 50 begins to rotate relative to the trim connection plate 30 whereby the edge 80 of the arm 74 engages the rib 41. Further rotation of the replaceable trim 50 causes the edge 80 to be forced atop the rib 41 (see FIG. 9) and against the bias of the arm 74 generally causing greater interference with the rib 41. As the replaceable trim 50 continues to rotate, the edge 80 moves along the surface of the rib 41 until seating within the first opening 40, and whereby the first section 76 of the arm 74 generally straddles the rib 41 to provide positive mechanical coupling interengagement therebetween, as shown in FIG. 10. The replaceable trim 50 can be disengaged and removed from the trim connection plate 30 by a generally reverse operation, rotating the trim piece relative to the connection plate in the opposite direction with sufficient force to disengage the edges 80 of the clips 70 from the first openings 40, and retracting the clips from the second openings 42.

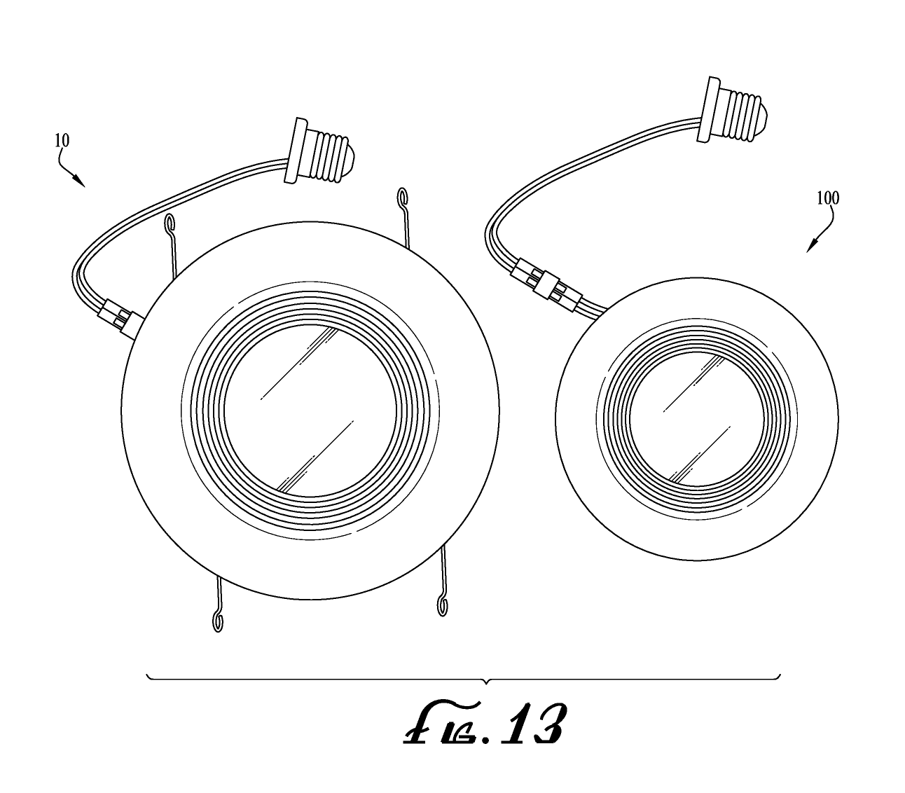

As described above, and according to one example embodiment, the baffle 64 of the replaceable trim 50 may comprise one or more steps 66 to provide an undulating or non-smooth surface (see FIG. 11). Alternatively, as depicted in FIG. 12, a replaceable trim 50′ may be provided and comprise a baffle 64′ having a substantially smooth surface 66′. Optionally, one or more other surface features may be provided as desired. Preferably, the replaceable trim 50, 50′ may be colored or finished as desired. According to example forms, the replaceable trim can comprise a finish such as brushed nickel, bronze, black, chrome, white or otherwise finished as desired. Optionally, the baffle may be stepped, smooth, specular or comprises other surface features or patterns as desired. FIG. 14 shows several different styles of replaceable trim members 50, 50′, 50″, which can be interchangeably installed on the retrofit fixture 10, enabling a consumer or user to select different decorative appearances for the fixture.

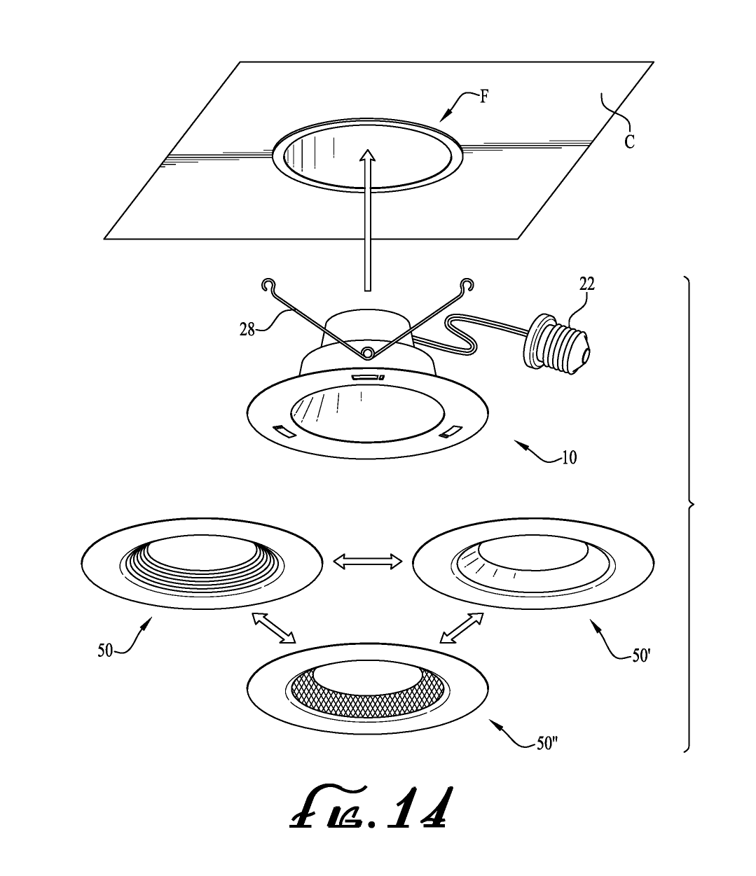

FIG. 13 shows the retrofit downlight 10 and a retrofit downlight 100, which is generally smaller in size than the previously described retrofit downlight 10. According to example forms, the retrofit downlights 10, 100 may be sized for compatibility with various preexisting downlight fixture formats, or for different applications. For example, according to example forms, the downlights 10, 100 may come in various sizes such as a 3″, 4″, 5″, 6″, 8″ or 10″ (nominal) fixture size formats. With any of the sizes, the downlights 10, 100 preferably comprise a replaceable trim of coordinating size and mounting configuration, for example, so that the user can pick and choose the best trim (e.g., color, finish, baffle style) that most suits their desired appearance and needs. The present invention is adaptable for use in connection with fixed position downlight fixtures, repositionable “eyeball” downlight fixtures, and various alternate fixture formats.

While the invention has been described with reference to preferred and example embodiments, it will be understood by those skilled in the art that a variety of modifications, additions and deletions are within the scope of the invention, as defined by the following claims.

What is claimed is:

1. A retrofit downlight apparatus comprising:
a housing configured for retrofit installation within a preexisting ceiling downlight fixture, a light module comprising a light source, and at least one mounting arm for securing the housing within the preexisting ceiling downlight fixture;
a trim connection plate extending from the housing, and comprising at least one first trim coupling element; and
at least one interchangeable trim piece, each interchangeable trim piece comprising at least one second trim coupling element, the first and second trim coupling elements being cooperatively interengageable to provide removable positive mechanical attachment of the trim piece with the trim connection plate.

2. The retrofit downlight apparatus of claim 1, wherein the light source comprises at least one light emitting diode.

3. The retrofit downlight apparatus of claim 1, wherein the at least one mounting arm for securing the housing within the preexisting ceiling downlight fixture comprises a pair of spring-biased mounting arms.

4. The retrofit downlight apparatus of claim 1, further comprising an electrical plug compatible with a socket of the preexisting ceiling downlight fixture, and electrically conductive wiring between the electrical plug and the light module.

5. The retrofit downlight apparatus of claim 4, further comprising a detachable connector between the electrical plug and the light module.

6. The retrofit downlight apparatus of claim 4, wherein the electrical plug comprises a threaded Edison coupling.

7. The retrofit downlight apparatus of claim 1, wherein each of the at least one first trim coupling elements comprise first and second slotted openings extending through the trim connection plate.

8. The retrofit downlight apparatus of claim 7, wherein each of the at least one second trim coupling elements comprise a resilient clip configured for insertion through one of the first and second slotted openings, and positive mechanical engagement within the other of the first and second slotted openings.

9. The retrofit downlight apparatus of claim 8, wherein positive mechanical engagement of the resilient clip with the other of the first and second slotted openings is provided by rotation of the at least one interchangeable trim piece relative to the trim connection plate.

10. The retrofit downlight apparatus of claim 1, wherein each of the at least one interchangeable trim pieces comprises an annular collar having a central opening, an outer ring, and a baffle extending obliquely inward from the annular collar and surrounding the central opening.

11. The retrofit downlight apparatus of claim 1, comprising a plurality of interchangeable trim pieces, each having a different external appearance.

12. The retrofit downlight apparatus of claim 1, comprising three circumferentially spaced cooperating pairs of first and second trim coupling elements

13. A retrofit downlight apparatus comprising:
a light source mounted within a housing, the housing comprising a trim connection plate having a plurality of trim connection openings extending therethrough; and
a trim member comprising a central opening, an outer trim ring, and a central baffle between the outer trim ring and the central opening, the trim member further comprising a plurality of trim engagement clips extending from the outer trim ring, each trim engagement clip configured for cooperative engagement with a corresponding one of the trim connection openings.

14. The retrofit downlight apparatus of claim 13, wherein the housing is configured for retrofit installation within a preexisting ceiling downlight fixture, and further comprising spring-biased mounting arms attached to the housing for engagement with the preexisting ceiling downlight fixture.

15. The retrofit downlight apparatus of claim 13, wherein the trim connection openings comprise first and second slots, and wherein the trim engagement clips are received through one of the first and second slots and positively engage the other of the first and second slots.

16. The retrofit downlight apparatus of claim 13, wherein the trim connection plate comprises a radial array of three evenly spaced trim connection openings.

17. The retrofit downlight apparatus of claim 13, wherein the trim member further comprises a lip extending around an outer periphery of the outer trim ring.

18. The retrofit downlight apparatus of claim 13, wherein the light source comprises at least one light emitting diode.

19. The retrofit downlight apparatus of claim 13, further comprising an electrical plug compatible with a socket of a preexisting ceiling downlight fixture, and electrically conductive wiring between the electrical plug and the light module.

20. The retrofit downlight apparatus of claim 19, further comprising a detachable connector between the electrical plug and the light module.

21. The retrofit downlight apparatus of claim 19, wherein the electrical plug comprises a threaded Edison coupling.

22. The retrofit downlight apparatus of claim 13, comprising a plurality of interchangeable trim members, each trim member having a different external appearance.

23. A retrofit downlight apparatus comprising a housing, a light module comprising an LED light source mounted to the housing, and a trim connection plate extending from the housing and having at least three trim connection openings extending therethrough; the retrofit downlight apparatus further comprising at least one interchangeable trim piece, the at least one interchangeable trim piece comprising at least three engagement clips, each engagement clip configured for cooperative interengagement with one of the trim connection openings to attach the at least one interchangeable trim piece to the housing.

24. The retrofit downlight apparatus of claim 23, wherein the housing is configured for mounting within a preexisting ceiling downlight fixture, and further comprising spring-biased mounting arms attached to the housing for engagement with the preexisting ceiling downlight fixture.

25. The retrofit downlight apparatus of claim 23, comprising a plurality of interchangeable trim pieces, each having a different external appearance.

26. A method of installation of a retrofit downlight apparatus, the apparatus comprising a housing, a light module mounted to the housing, and a trim connection plate extending from the housing and having at least one trim connection feature provided thereon, the method comprising selectively attaching a selected one of a plurality of visually different interchangeable trim pieces by positive mechanical engagement of the selected trim piece with the at least one trim connection feature of the trim connection plate.
